(19) United States
(12) Patent Application Publication
(10) Pub. No.: US 2004/0021280 A1
(43) Pub. Date: Feb. 5, 2004

(54) Method and apparatus for moving shelf units including moving shelf units arranged in a gondola having the shelves fully loaded with goods

(76) Inventor: Johnny L. Peggs, San Dimas, CA (US)

Correspondence Address: EDWARD J. DARIN, INC., 301 EAST COLORADO BLVD, SUITE 518, PASADENA, CA, 91101, US

(21) Appl. No.: 10/212,537

(22) Filed: Aug. 5, 2002

(51) Int. Cl. B62B 1/00

(52) U.S. Cl. 280/47.24

(57) ABSTRACT

A safe, economical, and time saving method and apparatus for moving shelves, arranged in the form of a gondola including fully loaded shelves. Two, two wheel lifting hand trucks having a lifting arm extending outwardly therefrom and adapted to be slidably moved under a shelf supporting foot, the entire width of the shelf, and simultaneously lifting from opposing ends the lifting trucks. A skate having a platform for supporting the width of a mounting foot is provided and carrying swiveling casters. The lifting hand trucks are used to lower the supporting foot onto the skate. The skate has a coupling loop for receiving a pulling tool to roll the gondola on the skates while pulling on the skates. The skates include means for preventing relative movement between a shelf unit and the skate.

### FIELD OF INVENTION

The present invention relates to methods and apparatus for moving shelf units of the type commonly used in super market chains or the like including shelf units arranged as a gondola of units fully loaded with goods from one location to another.

### BACKGROUND OF INVENTION

Large supermarket chains, home improvement stores, department stores and the like display their goods on a series of shelf units for storage and display purposes and ease of access to the customers. In some of these stores a series of free standing shelf units are arranged side by side in a gondola of shelves that may run for 80 feet and weigh in the order of 40,000 to 60,000 pounds when fully loaded. These shelf units generally are non-refrigerated shelf units. These stores are remodelled from time to time and may include replacing the flooring under the shelf units or a re-arrangement of the shelf units thereby requiring the shelves to be moved to a different location within the store. Various methods and apparatus have been used to move the shelf units including fully loaded shelf units yet none have been proven to be completely commercially satisfactory. As a result, it is necessary to unload the shelves prior to moving them, which is very time consuming and expensive, and then position them back onto the shelves after they have been moved to a new location or the flooring has been replaced and the shelf units are returned to their original position on the new flooring surface.

One of the problems with prior art apparatus and moving systems is the time required to set up the apparatus may be too long, i.e. two hours, to negate the advantage of using the apparatus. The weight of a gondola of shelf units obviously varies with the type of goods stored and displayed on the shelves and the method of moving a gondola must be such that the goods do not fall off from their shelves during the moving procedure. Liquids, for example, stored in glass containers and canned goods render the movement of gondolas loaded with such goods to be very heavy, very difficult to move and time consuming. The destruction of the goods may result if glass containers fall off the shelves during the moving procedures and if expensive liquids, such as liquors, for example, are destroyed it may negate the advantages of using a particular apparatus for such goods. Liquor containers may store expensive liquors so that the breaking of only a few bottles can negate the use of a particular moving system.

The prior art discloses methods and apparatus for moving fully loaded shelving units as exemplified by U.S. Pat. Nos. 4,699,391; 5,716,186 and 5,782,600. The Jensen structure disclosed in the '186 patent has been found to require too long a period of time to set up the apparatus prior to moving the units. Other prior art is known for moving heavy objects such as copying machines as disclosed in the Lee U.S. Pat. Nos. 3,633,774 and 3,809,261. The Grassick U.S. Pat. No. 2,296,610 discloses apparatus for moving loaded counters, while the Dunaski U.S. Pat. No. 3,145,683 discloses apparatus for moving furniture such as loaded desks. Similarly, the Jones U.S. Pat. No. 3,370,725 discloses apparatus for moving various types of furniture. None of these prior art devices or systems are known to be commercially feasible particularly for moving a gondola of loaded shelf units in a safe, efficient, time saving and economical manner. Accordingly, there is a present need for an improved method and apparatus for moving a gondola of fully loaded shelf units with a minimum amount of time, without a long setup time, without damage to or loss of goods during transit and without potential injury to the moving personnel.

### SUMMARY OF INVENTION

The present invention comprises simple, safe, relatively quick, economical and efficient method and apparatus for moving free standing shelf units, particularly useful for moving a gondola fully loaded with goods on the shelf units from one location to another without damage to or loss of any of the stored goods and injury to the moving personnel and apparatus for temporarily lifting the loaded shelf units to permit a wheel mounting skate to be moved under the shelf units for mobilizing the gondola and permitting it to be moved to a different location.

From a method standpoint, the present invention broadly contemplates that the free standing shelving units of a gondola having vertical feet for supporting the shelf unit on a supporting surface including when the shelving units are fully loaded with goods wherein the method comprises providing a pair of lifting devices in the form of a two wheel, heavy duty lifting hand cart having a lifting plate adapted to be slidably moved under a shelf supporting foot for lifting one side of a shelf unit a pre-selected distance upwardly, the lifting plate being arranged substantially centrally of the two wheel cart, simultaneously moving another one of the lifting devices to the opposite end of the same mounting foot a pre-selected distance upwardly above the supporting surface,

providing a skate having swiveling casters for supporting the mounting feet of the shelf unit the entire width of a shelf unit,

while the mounting foot is elevated from both ends, sliding the skate between the wheels of the lifting hand cart in alignment with said lifting plate from one end of the elevated mounting foot to the opposite end thereof and then lowering the shelf mounting foot onto the skate to be supported thereon and movable therewith,

moving the lifting cart away from the shelf unit and permitting the shelf mounted foot to be supported by and movable with the skate,

repeating the above steps for the remaining mounting feet of the shelf units comprising the gondola and thereby mobilizing the gondola via the skates to permit the gondola to be rolled to another location.

The method further contemplates providing stop means adjustable mounted to each skate means at opposite ends thereof for securing a vertical shelf mounting foot thereon when mounted on the skate to prevent relative movement between the mounting foot and the skate during a moving operation and providing a plurality of lever pulling means connectable to and disconnectable from an individual skate means, one lever means for each skate mounted to the gondola and simultaneously pulling on all of the lever pulling means for moving the entire gondola to a different location.

From a structural standpoint, the invention contemplates the use of a heavy duty lifting hand truck comprising a heavy duty cross bar, an individual, wheel mounting element secured adjacent each end of the cross bar to depend therefrom with the wheel means coaxially mounted thereto for maintaining said wheel mounting elements spaced from said supporting surface when the wheels are supported therefrom, a lifting arm is secured at one end to said crossbar intermediate the ends thereof at a pre-selected angle and having a lifting end adapted to be slidably moved under a shelf supporting structure for temporarily lifting a shelf supporting structure upon a lifting force being applied thereto and a lever means secured to the cross bar intermediate the ends of the cross bar and adapted for permitting the manual movement of the lifting hand truck, the lever means extending outwardly and upwardly from said cross bar at a pre-selected angle with the supporting surface and a pre-selected operative length to provide a lifting force to a shelf supporting structure including when the shelf is fully loaded with goods upon the rotation of the lever means in a counter-clockwise direction.

In addition to the lifting hand trucks, the invention contemplates the use of skates for placement under the elevated shelf supporting structure for rendering the entire gondola mobile so that it can be rolled to a new location. The skates can be constructed and defined to support the shelf supporting structure for either a single side shelving unit or a double side shelving unit so that the skate extends and supports the entire shelf supporting unit of each kind. To this end, the skate comprises a U-shaped channel constructed and defined to receive and partially support at least a pair of supporting feet, side by side, within the channel for a pair of shelving units arranged side by side upon being mounted onto the channel, the skate further includes a plurality of caster wheel support assemblies, each assembly having an inverted “L” configuration with one leg of the “L” secured to the outside wall of the channel adjacent opposite sides of the channel and adjacent each end of said channel, a corresponding plurality of swiveling caster wheel assemblies for the support assemblies is provided, one caster wheel assembly secured to an individual support assembly, and a plurality of stop means mountable adjacent the opposite ends of the U-shaped channel for locking the shelf supporting structure in place to prevent relative movement between the two.

### BRIEF DESCRIPTION OF THE PREFERRED EMBODIMENT

These and other features of the present invention may be more fully appreciated when considered in the light of the following specifications and drawings, in which:

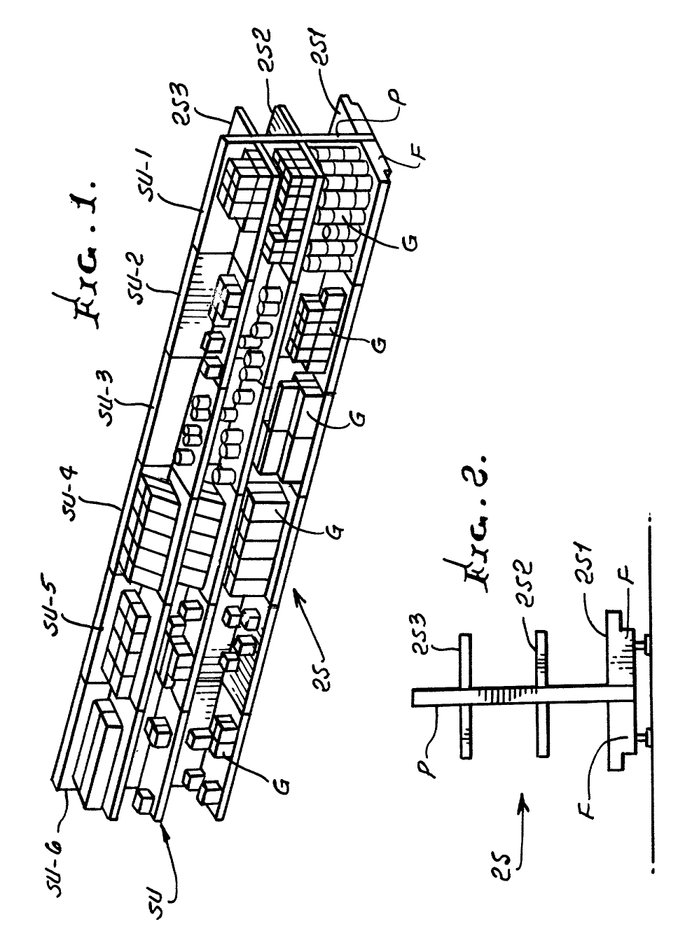

FIG. 1 is a diagrammatic longitudinal view of a conventional, double sided shelf units arranged in the fashion of a gondola with one side loaded with various goods;

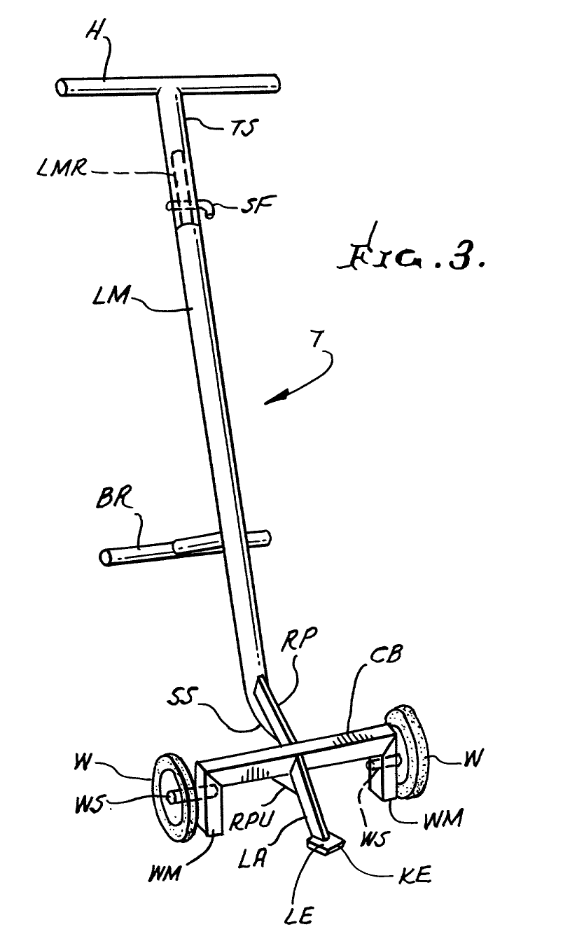

FIG. 2 is an end view of the unloaded shelf units of FIG. 1;

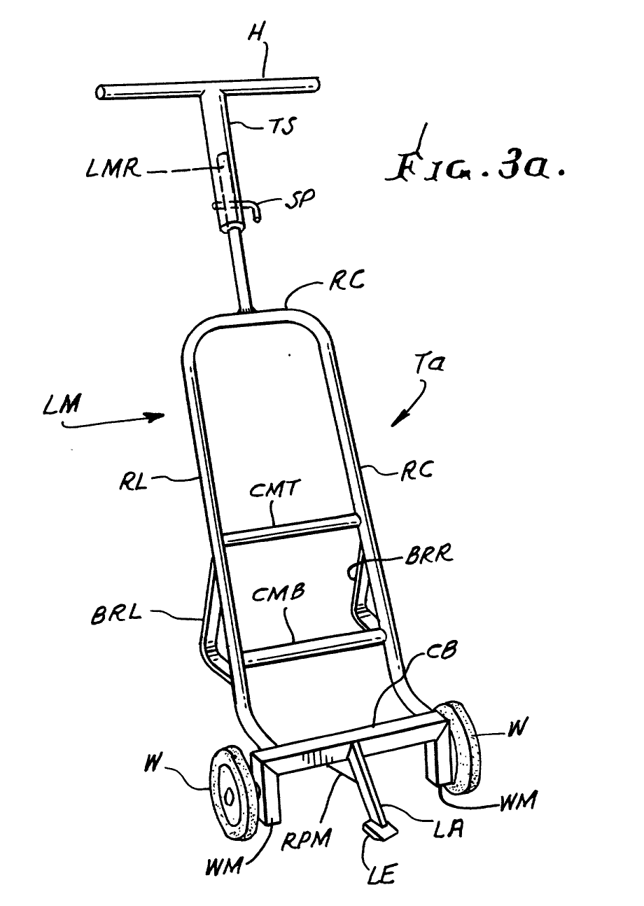

FIG. 3 is a front elevational view of a two wheel lifting hand truck embodying the present invention;

FIG. 3a is a front elevational view of an alternate design for a two wheel lifting hand truck embodying the present invention;

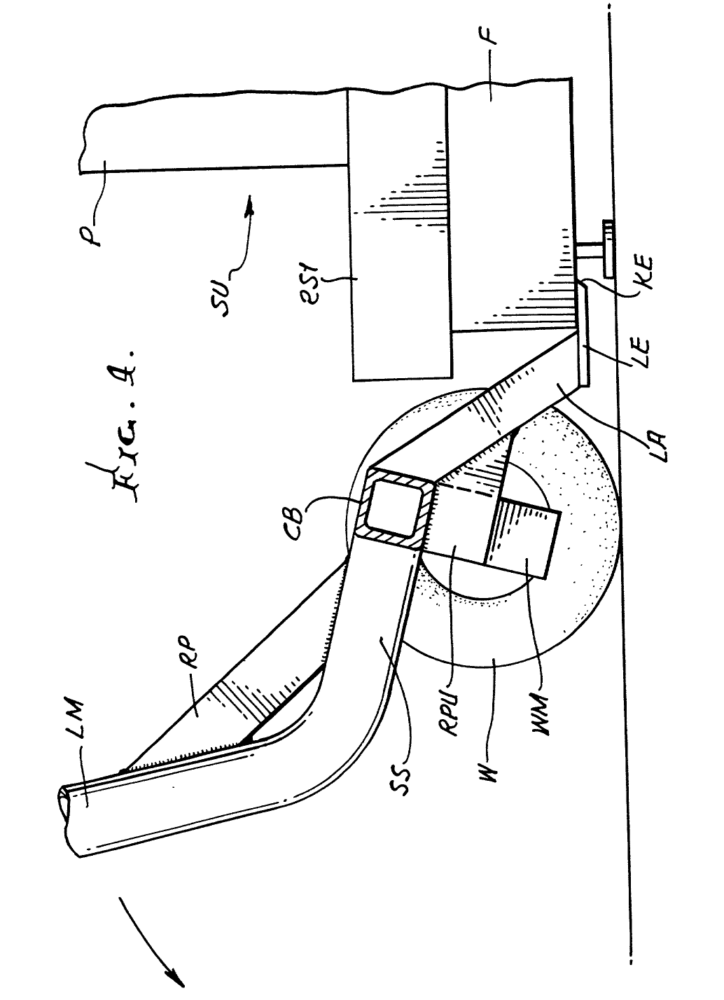

FIG. 4 is an enlarged partial view of the lifting arm for the two wheel lifting hand trucks of FIGS. 3 and 3a positioned under the supporting structure of the shelving unit intermediately prior to the application of a lifting force thereto;

FIG. 5 is a detached view of a skate embodying the present invention and illustrating, in dotted outline, the positioning of a double sided shelf unit thereon;

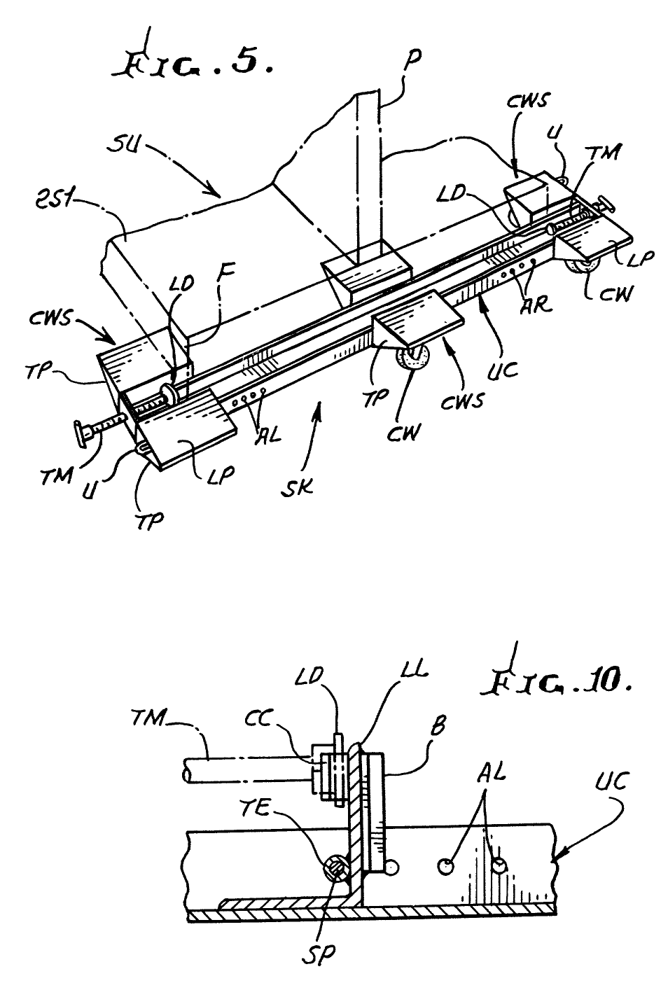

FIG. 6 is a top plan view of a skate in accordance with the skate of FIG. 5;

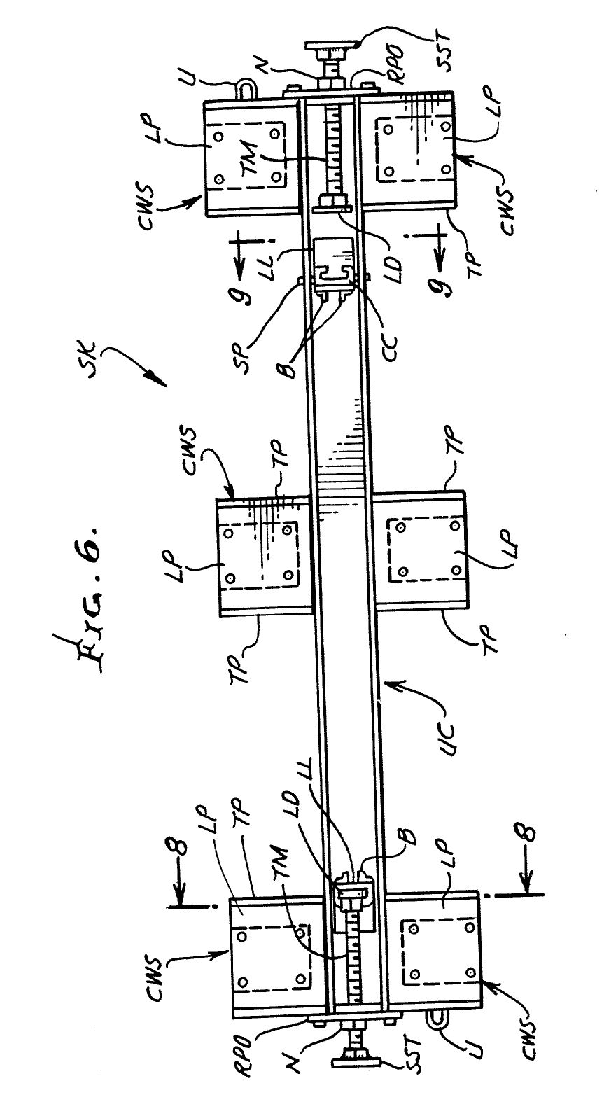

FIG. 7 is end view of the skate illustrated in FIG. 6 with a supporting structure mounted thereon illustrated in dotted outline;

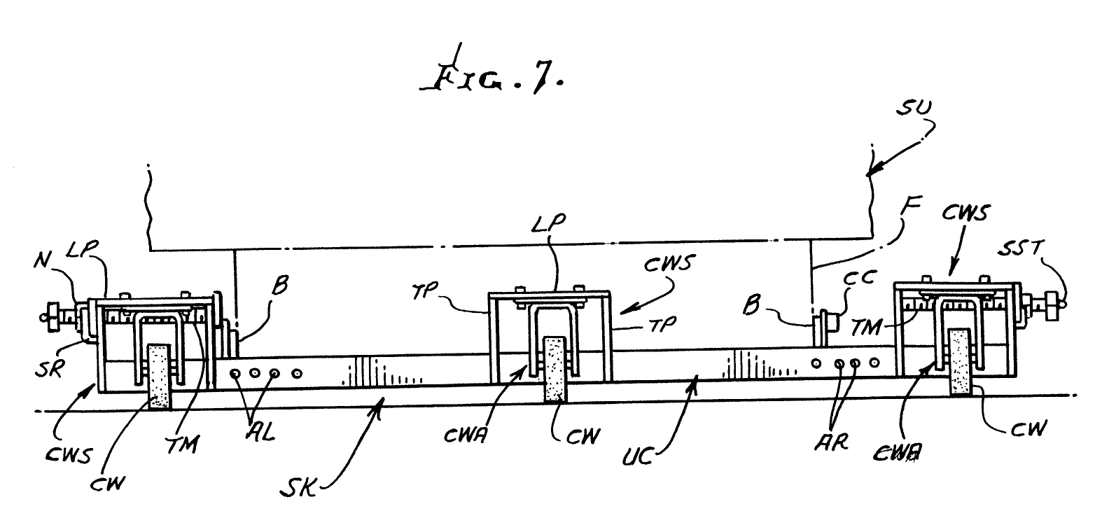

FIG. 8 is a sectional view taken along the line 8-8 of FIG. 6 and illustrating a shelf supporting structure mounted to the skate;

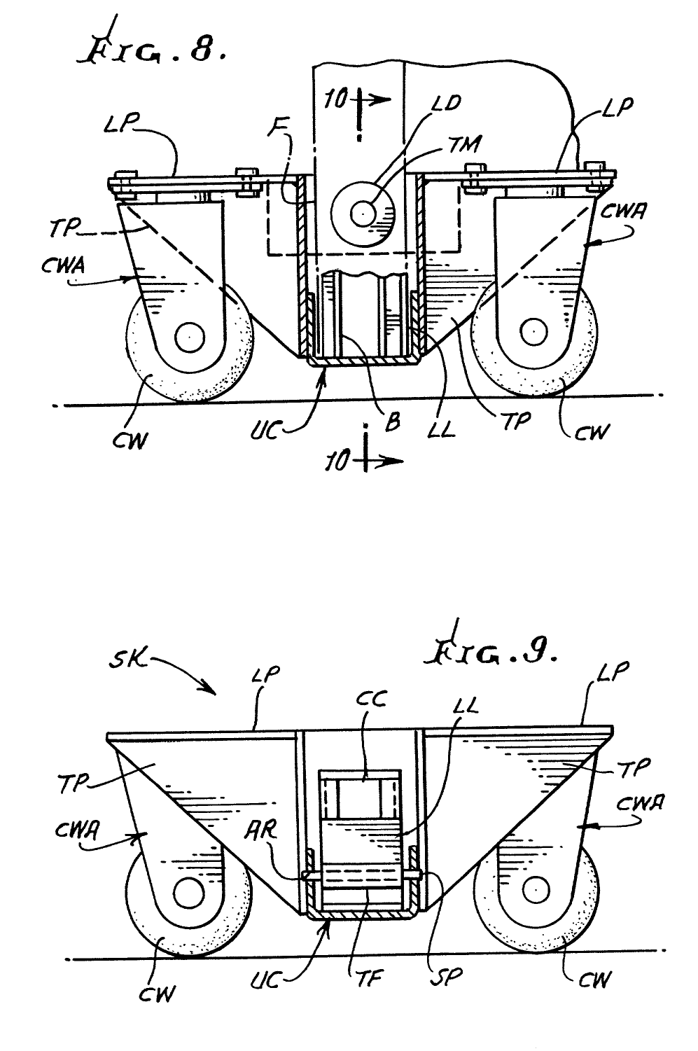

FIG. 9 is a sectional view taken along the line 9-9 of FIG. 6;

FIG. 10 is a sectional view taken along the line 10-10 of FIG. 8 and illustrating adjustable stop for holding the shelf supporting structure in place when supported by the skate and illustrated in a secured position;

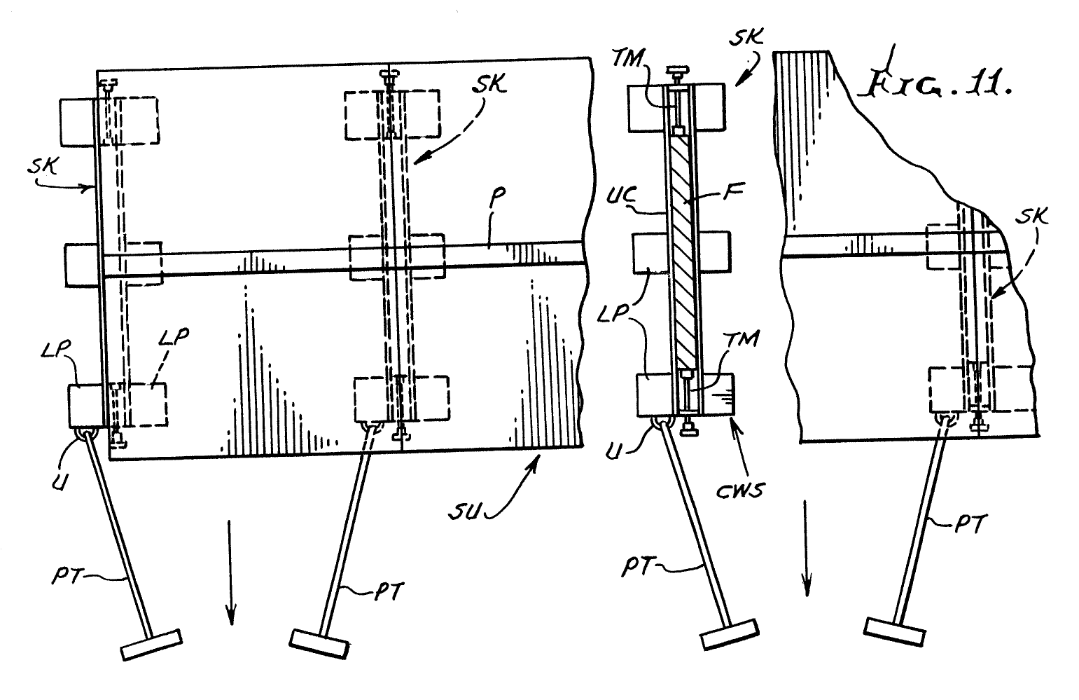

FIG. 11 is a top plan, diagrammatic view of a gondola of shelf units, with portions broken away, and illustrating the position of the skates and the pulling tools secured to the individual skates;

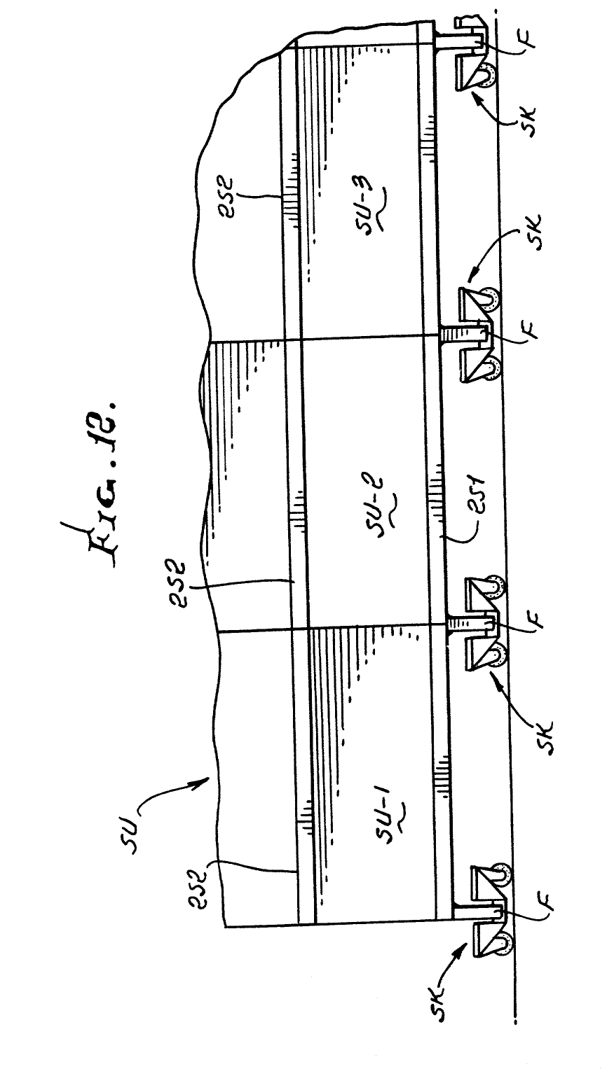

FIG. 12 is a front elevational view of a portion of a gondola of shelves mounted on the skates;

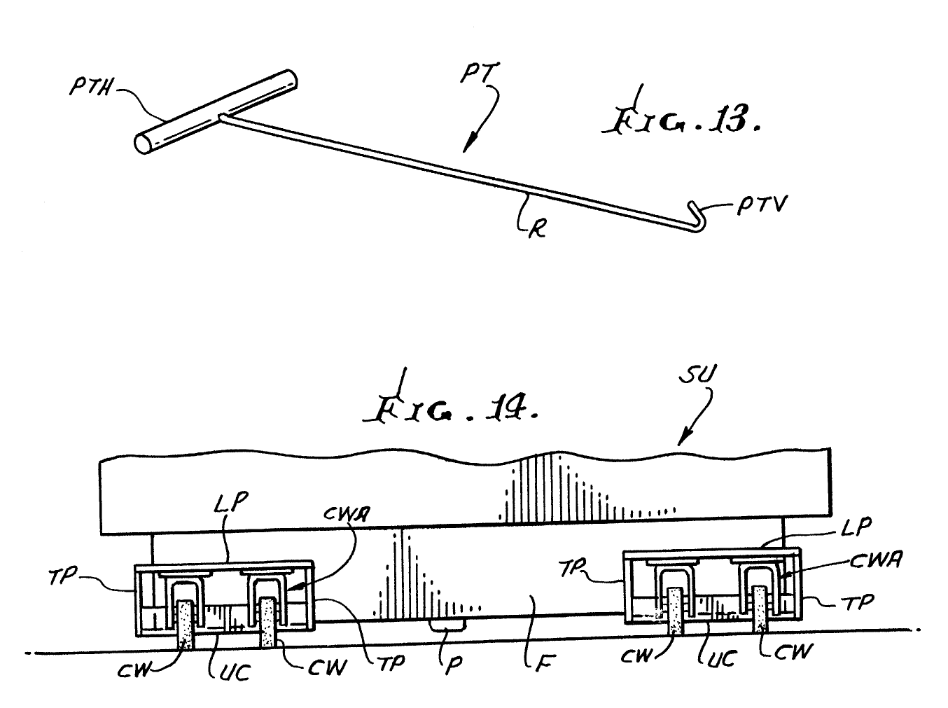

FIG. 13 is a longitudinal view of the detached, pulling tool for the skates in accordance with pulling tool for the skates in accordance with the present invention; and

FIG. 14 is an end view of a alternate configuration of a pair of skates mounted on opposite sides of a double sided shelf unit.

### DETAILED DESCRIPTION OF THE PREFERRED EMBODIMENT

Now referring to the drawings, the method and apparatus for moving a gondola of fully loaded shelves in accordance with the present invention will be described. The method and apparatus of the invention contemplates shelving units that may be three or four feet in length and arranged in the fashion of a gondola without securing the free standing shelving units to each other with fasteners or the like. The structural strength of the construction of the shelves is such that the use of fork lift trucks can not be used. The apparatus contemplated by the present invention is heavy duty apparatus and useful for moving fully loaded gondolas that may run as long as 60 feet in length so that when fully loaded may weigh 40,00 to 60,000 pounds. The invention is best appreciated by first examining the type of shelving units forming a gondola for the purposes of the present invention by viewing FIGS. 1 and 2. These figures illustrate a typical two sided shelf unit 2S with each side having three display shelves 2S1, 2S2 and 2S3 vertically mounted to a central post P. The first shelf 2S1 is typically mounted 6 inches off of the floor or supporting surface. Each shelf unit 2S typically extends three or four feet in length and are mounted in a free standing, side by side relationship to form a gondola of a preselected length. Below the first shelf 2S1, opposing vertical feet F for supporting the individual shelf units SU are provided at opposite ends thereof. One side of the gondola of shelving units is illustrated loaded with goods G on the shelves of the shelving units SU with the shelves on the opposite side of the shelving units SU-1, SU-2, etc. being empty for simplification purposes. A single side shelf unit would be one-half of the size of a double sided unit and has shelves on only one side of the shelf units.

The initial step in moving a shelving unit SU or a gondola of units is to temporarily lift one side of the shelf for rendering it mobile by a skate or the like. The lifting device contemplated by the present invention is the preferred embodiment of FIG. 3 comprising a two wheel lifting hand truck T. The lifting hand truck T is constructed with a heavy duty cross bar CB which may be in the form of a two inch square tube having a wall of approximately ¼ inch and 18 inches in length. The ends of the cross bar CB are cut on an angle to accommodate wheel mounting elements WM secured thereto. The wheel mounting elements are identical and may be in the form of a two inch square tube having a ¼ inch wall and a length of 6 inches, as illustrated. Each wheel mounting element WM is adapted to mount a wheel W of 8 inches by 2 inches having a hard rubber tire secured thereto. The wheels W are coaxially mounted by means of a stub shaft WS welded or otherwise secured to an individual wheel mounting element WM with the wheels journaled thereto in a conventional fashion. The wheels W are sized relative to the wheel mounting elements WM to space the free ends of the elements WM from a supporting surface engaging the wheels W. Intermediate the ends of the cross bar CB is provided lifting arm LA preferable arranged centrally of the cross bar CB and secured thereto. The lifting arm LA may be constructed of a flat steel bar that is secured at one end to the bar CB by welding or the like and extends outwardly therefrom at a preselected angle and having a lifting end LE adapted to be slidably moved under a shelf supporting structure or shelf foot. The lifting end LE may compromise a flat steel plate welded to the free end of the lifting arm LA at a right angle thereto. The lifting end LE is preferably provided with a knife-like end KE for readily slipping under a shelf-supporting structure for commencing lifting operation, as best illustrated in FIG. 4.

The lifting hand truck T is completed by the provision of lever means LM secured to the cross bar CB intermediate the ends of the cross bar. The lever means LM may be in the form of a heavy duty tubular structure having a pre-selected length for obaining the necessary mechanical advantage for a lifting force applied thereto and permitting the ready manual movement of the lifting hand truck T. The tubular lever means LM has a straight end section SS at the cross bar CB and is bent to assume an angle on the order of 65 degrees with the section SS for extending outwardly and upwardly from the cross bar CB and a pre-selected length. The length of the lever means LM may include an extension in the form of a T-section TS as illustrated in FIG. 3 that slides over the free end of the lever means LM that is provided with a reduced diameter to permit the T-section to be telescoped thereto, as illustrated, and appropriately secured thereto by a slide fastener SF or the like. The T-section TS has a handle H at the end thereof to permit more than one individual to exert a lifting force on the lever means LM at the handle H. A reinforcing plate RP can be secured to the cross bar CB and lever means LM by welding or the like, as illustrated for further strengthening the lever means and render it suitable for heavy duty lifting. A further reinforcing steel plate RPU is welded to the lifting arm LA and at the bottom of cross bar CB; see FIG. 3.

The overall length of the lever means LM including the T-section TS has been selected to obtain the desired mechanical advantage for lifting a shelf unit with loaded goods and for the purposes of the present invention may be on the order of 53 inches. The T-section TS may be approximately 20 inches in length and the reduced diameter section LMR that interfits with section TS may be 10-11 inches in length. It should be recognized by those skilled in the art that the extension TS need not have a T-like handle but be merely a tubular section. The 2 piece design for the lever means LM allows for ease in transporting the two wheel lifting hand truck T but could be of one piece construction. The hand truck T in order to lift or elevate a shelf unit of a gondola for the purposes of moving a gondola of units should be capable of lifting on the order of 3000 pounds. The lifting force is applied to the lever means LM by the moving personnel applying a counter-clockwise force to the lever means LM as illustrated in FIG. 4.

The lifting hand truck T is provided with a brace BR welded to the lever means LM intermediate its end for supporting the hand truck T at a pre-selected distance above the supporting surface so that the entire hand truck T need not be lifted in its entirety from the supporting surface for ease of use. The brace BR can be formed in the shape of an angle of 60 degrees having two arms of different lengths.

The arrangement of the lifting arm LA is constructed and designed to extend outwardly of the bar CB at a pre-selected angle so that the end LS will assume a flat, parallel relationship with a supporting surface mounting the truck wheels W. Accordingly, when a clockwise or upwardly acting force is applied to the lever means LM to move the lever means to a substantially vertical position relative to the supporting surface, the sliding movement of the lifting end LE towards and under a structure to be elevated can be started. The provision of the knife-like end KE for the end LE also facilitates the inter engagement of the lifting end LE and the structure to be lifted with the continued movement of the end LE towards and under the object to be elevated as best illustrated in FIG. 4. At this time the lifting force or counter-clockwise force can be applied to the lever means LM for transmitting the lifting force to the object to be elevated under a shelf supporting structure.

Now referring to FIG. 3a, an alternate, non-preferred embodiment of the lifting hand truck T is illustrated and will be described and illustrated as the truck Ta. The lifting hand truck Ta of FIG. 3a is basically the same structure as the truck T of FIG. 3 except that the lever means L a comprises a pair of side rails RL and RR that are secured to the cross bar CB adjacent opposite ends of the bar CR, as illustrated. The two side rails are formed in the shape of a “U” with a top connecting portion RC joining the two side rails.

The side rails RL and RR are interconnected by cross members CMT and CMB by welding or the like. Each side rail RL and RR is also provided with individual braces BRL and BRR shown arranged between the cross members CMT and CMB to function as a rest in the manner of the brace BR of FIG. 3. The wheel structure and lifting arm construction of the truck Ta is identical to the structure for truck T and bear the identical reference numbers in both FIGS. 3 and 3a.

The above described structure for the side rails RL and RR in the form of a “U” may comprise lever means LM for the entire truck Ta. For the purposes of the present invention, the side rails RL and RR may extend to approximately 67 inches and spaced 18 inches and apart and can be constructed of heavy piping. In this arrangement, the section RC of the “U” functions as a handle for the truck Ta.

Alternately, an extension LM a having a reduced end section LMR can be welded or secured to the rail section RC to complete the truck Ta or further modified by an extension sleeve or T-section TS, as illustrated in FIG. 3a. All of the embodiments disclosed herein and equivalent structures for the two wheel lifting hand truck are useful for readily moving the lifting arm LA under a shelf supporting structure or foot F and after the application of a lifting force to the lever means LM by one or two individuals, the shelf supporting structure will be elevated to a pre-selected height. In this application, the height that the supporting structure is elevated is dependent on the size of the wheeled mechanism selected for mobilizing the loaded gondola. The wheeled mechanism in accordance with the present invention is referred to as a skate SK or gondola skate SK and as illustrated in FIG. 5 is constructed, designed and proportioned for mobilizing a double side shelf unit 2S utilized in a gondola.

Now referring specifically to FIGS. 5-10, the mobilizing skate SK of the present invention will be described in detail. It should be recognized by those skilled in the art that a simple sided shelf unit can be mobilized by proportioning the skate SK of a length to merely accommodate the designed width of a single sided shelf unit or to shorten the length of the skate. The illustrated skate SK is adapted to extend and support the width of a double sided shelf unit 2S when both ends are elevated to permit a skate SK to be moved from one side of the shelf unit 2S to the other side or a typical length on the order of 49 inches. The skate SK is illustrated in FIG. 5 and also shows in dotted outline the mounting of a shelf unit SU and the shelf mounting foot F relative to the top side of the skate SK. The skate SK comprises a U-shaped channel UC constructed, designed and proportioned to receive and support at least a pair of supporting feet F for shelf units arranged in a free standing, side by side relationship, as per the gondola of FIG. 1, when mounted to the channel UC. The skate SK further includes a plurality of wheel support assemblies CWS corresponding to the opposite ends of the shelf unit SU and the central post P; see FIGS. 5-7 in particular. The wheel support assemblies CWS each comprises an individual inverted L configuration constructed of a L shaped steel plate LP with one leg of the L being secured by welding or the like to the outside of the U-shaped channel UC. The secured leg of the L shaped plate LP has its free end terminating co-extensively with the bottom of the upstanding arm for the channel UC, as can be seen from viewing FIG. 5. The open ends of the L shaped plate are closed by triangular shaped plates TP secured thereto, as illustrated. The secured arm of the plate LP extends above the top of the U channel UC. The top arm of the plate LP extends outwardly of the channel UC and carries the wheels for mobilizing the shelf unit(s) or gondola. For this purpose swiveling casters were selected and are secured to the bottom side of the outwardly extending top arm of plate LP. Commercially available caster wheel assemblies CWA sized as 3 inch by 1 ½ inch casters are secured to the bottom of plate LP by fasteners, four fasteners for each caster assembly; see FIGS. 6 and 7. The caster wheels CW ride on the supporting surface and are essentially co-extensive thereon with the bottom side of the channel UC. This selection of the swiveling casters permits movement of the skate SK in all directions. The above construction and arrangement of the caster wheel assembly CWA are identical for each of the illustrated assemblies. The caster wheel assemblies CWA are mounted to the opposite sides of the channel UC at opposite ends and on the opposite sides of the channel UC corresponding to the position of the shelf post P or essentially centrally of the channel UC. The thus defined skate SK will support approximately 3000 pounds.

An important feature of the skate SK is the provision of means for locking the shelf mounting structure to the skate so as to prevent relative movements between the skate and the shelf foot F or shelf mounting structure during the movement of a shelf unit or gondola of units. Recognizing that the widths of shelf units SU vary in size the locking means of the present invention is designed to accommodate the different sizes as will be explained hereinafter.

The means for locking the shelf mounting structure to the skate comprises a heavy duty threaded member TM having a nut secured at one end with a locking disc LD secured to the nut, by welding or the like. The opposite end of the member TM carries a rectangular plate RPO having a central opening sized to accommodate the threaded member. Secured to the plate RPO at the central opening is a threaded nut N and is threadingly engaged with the threaded member TM. The adjacent end of the member TM has a threaded nut secured to the end with a short stub shaft SST welded thereto to function as a manual means for rotating the threaded member TM in accordance with the direction of rotation imparted to the shaft SST. For this purpose the shaft SST is mounted to the cooperating nut N transversely of the nut and extends outwardly thereof, for ease in rotating the threaded member TM. The skate SK is provided with a receptacle for mounting and securing the plate RPO thereto. In the disclosed embodiment the plate receptacle is defined by welding a receptacle plate to the ends of the caster wheel support assemblies CWS in a spaced relationship with the triangular plates TP on opposite sides of the channel UC permitting the plate RPO to be slidably mounted to the resulting receptacle and secured thereto. For this purpose the plate receptacle or socket has a shallow U-configuration and holds the plate RP in a stationery position. It should be now evident that the rotation of the shelf SST in a clockwise rotation causes the threaded member TM to longitudinally advance so as to change the distance between the plate RPO and the locking disc LD to accommodate the size of the shelf mounting structure or foot F. Each end of the skate SK is defined with a plate receptacle SR and threaded member TM as illustrated in FIGS. 5-7 in particular.

In addition, to the above described structure the means for locking the shelf mounting structure includes an L-shaped stop member LL that can be mounted to the bottom of the U-channel UC at an area spaced longitudinally inwardly of the wheel support assemblies CWS. The stop member LL is secured to the channel UC side walls by means of a series of apertures longitudinally spaced and aligned for receiving a securing pin SP. The aligned and spaced apertures are positioned between the wheel support assemblies CWS as best illustrated in FIGS. 5 and 7. The apertures on the left hand wall of the channel UC, as viewed in FIG. 5, are identified as the apertures AL and the apertures on the opposite side of the channel UC are identified as the apertures AR. The apertures AL and AR are coaxially aligned with a similar row of spaced apertures on the opposite wall of the channel UC.

The stop member LL is provided with a tubular element TE secured to the upstanding arm of the member LL and arranged to be coaxially positioned between the apertures AL or AR in the walls of channel UC for slidably receiving the securing pin SP. The securing pin SP is slidably received within the tubular element TE when inserted into one of the apertures AL or AR. The aperture entry end of the pin SP mounts a yieldable ball (not shown) that moves inwardly as it moves through an aperture and then secures itself onto the channel wall of channel UC opposite to the entry aperture of the channel when it assumes a normal outward position. This prevents the pin SP from being readily withdrawn from its locking position but with sufficient force the ball will yield and permit it to be withdrawn from its locking position. The opposite end, the non-entry end of the pin SP may include a ring loosely secured thereto for permitting the pin to be manually withdrawn completely from the channel unit UC and re-positioned in accordance with the size of the shelf supporting structure.

The stop member LL is also constructed, designed and proportioned to be used with the threaded member TM for locking purposes. For this purpose the upstanding arm of the member LL is provided with a C-like clamp CC for receiving and mounting the locking disc CD therein. The clamp CC is mounted on the same side as the upstanding arm of the member LL as the tubular element TE but spaced and secured from the top thereof to be aligned to receive the locking disc CD at the adjacent end of the member TM; see FIG. 6 on the left hand side thereof. The opposite side of the arm of the stop member LL from the clamp CC, there is secured by welding or the like a pair of L-shaped protrusions or bumpers B, (see FIGS. 6 and 10) arranged along the vertical sides for engaging the shelf supporting structures or foot F and locking it to the skate SK when the plate RPO is secured in place in its receptacle SP. When the stop member LL is employed in this manner, it is not secured to the skate SK by means of the locking pin LP. The stop member LL can then be positioned against a shelf supporting structure by advancing the stop member LL longitudinally in accordance with the rotation of the threaded member TM to tightly engage the supporting structure to prevent relative movement between the shelving structure and the skate SK. Rotation of the threaded member TM in the opposite direction will cause the retraction of the stop member LL away from the shelving structure when the skate SK is to be removed.

In use, the skate SK has a length corresponding to the widths of the shelf units SU comprising the gondola of shelves. In this instance, the means for locking the shelf units SU to the skate SK comprises the above described combination of threaded member TM assembly and the stop member LL. One such combination of these elements are used at each end of the skate SK with the corresponding plates RPO mounted to their individual receptacles SP at each end of the skate. In this arrangement, the threaded members TM at each end are rotated to advance the corresponding stop member LL towards the shelf supporting structure to tie it tightly to the skate and eliminate any relative movement between the shelf units SU and the skate SK during the moving procedure.

In the event, the width of the shelf units SU are less than the length of the skate SU and the skate SK is to be locked to these smaller, double sided shelf units, the skate SK is used with the stop member LL and is secured to the skate by means of the securing pin SP, as described hereinabove and the threaded member TM is not utilized. In this case, the individuals moving the gondolas may measure the width of the shelf units and mount one of the stop member LL by means of a selected, individual aperture AL for defining one extremity of the shelf unit, and after the shelf unit is mounted to the skate SK against the positioned stop member, another stop member LL is secured in position by means of a selected, individual aperture AR to clamp and lock the other end of the shelf supporting structure to the skate SK in preparation for moving the gondola without relative movement between the skate and the shelving unit.

Another feature of the skate SK of the present invention is the means for engaging the skates once the shelf units are mobilized thereby for moving the gondola to a new location. The presently preferred structure for grasping the skate SK is the U-shaped coupling loop U welded to the triangular plate TP at each end of the skate SK as illustrated in FIG. 6, for example. The loop U comprises the coupling means for coupling a pulling tool PT to the skate so that a pulling force applied to the coupling means acts only against the skate proper. It is preferable that such a coupling means as the loop U is positioned on the skate SK so that it is readily accessible to the moving personnel and easy to grasp the coupling means. Equivalent coupling means may be employed such as a simple aperture in the plate TP. The coupling means for the skate SK is employed along with a pulling tool PT having an end designed and constructed to allow the tool to be readily coupled to the coupling means or loop U and to grasp the loop U or equivalent coupling element. In the utilization of the loop U, the pulling tool TP has a hook like end or V shape end PTV to readily permit coupling to the loop U. The pulling tool PT illustrated in FIG. 13 is suitable for use with the loop U. The pulling tool PT of FIG. 13 has a handle PTH secured to the end of the rod R forming the pulling tool.

With the above structure in mind, the method of moving gondolas including fully loaded gondolas will now be described. The method of moving the gondola of fully loaded shelves will be described for a gondola of the type of FIG. 1 and it will be understood by those skilled in the art that the movement of such a loaded, double sided gondola is directly applicable to a single sided gondola or a short gondola of shelves fully loaded. The method is initiated by the moving personnel moving the two—two wheel lifting hand trucks T, described herein, to the opposite ends of the width of a first shelving unit (i.e. SU-1) to position the lifting arms LA adjacent to and then under the shelf supporting structure or foot F for elevating the foot a pre-selected distance as illustrated in FIG. 4. With the simultaneous elevation of both ends of the same side of a shelf unit (SU-1) the pre-selected elevation is selected to permit a skate SK to be positioned under the elevated end of the shelf unit. For this purpose, while the foot F is maintained elevated, a skate SK is moved between the wheels of the truck T and preferably aligned longitudinally with the lifting arm LA. The skate SK is moved completely under the elevated foot to the opposite side of the shelf unit and beyond to position the skate SK to receive a mounting foot in the channel UC. Once so positioning the skate SK, the moving personnel cause the elevating force to be gradually reduced to cause the elevated foot F to reside in the channel UC in its entirety. At this time, the two hand trucks T are moved away from the gondola and the hand trucks are moved to the other end of the same shelf unit (SU-1) to elevate the corresponding vertical foot F and position another skate SK under this new foot F, and follow the same procedure as the procedure for the first mounting foot. Since a gondola of shelf units arranged side by side is under consideration, the adjoining foot F for the abutting shelf unit or the unit SU-2, as illustrated in FIG. 1 is mounted to the same skate SK. The same procedure is followed for the remaining shelf units comprising the gondola or the units SU-3, SU-4 - - - SU-6, etc. until all of the shelf units are mobilized with skate SK.

During the procedure of mobilizing the gondola of shelf units, the means for locking a shelf unit mounting structure is operated in accordance with the width of an individual shelf unit. If the shelf unit is of a standard width corresponding to the length of a skate SK, as illustrated in FIG. 5, for example, the locking means comprises the assembly of the threaded member TM and the stop member LL as illustrated in FIG. 6 and both ends of the foot F is so locked to prevent relative movement between the locked shelf units and the skates SK. In the event the shelf and the shelf units are of a width less than the width of the skate SK of FIGS. 5-7, the stop member LL is used for this purpose. Prior to elevating a shelf unit having a width less than the length of the skate, the moving personnel can measure the width of a shelf, resting the shelf unit on the skate SK adjacent the stop member LL on the channel UC adjacent the apertures AL, for example. After the shelf unit is so positioned the stop member LL is secured thereto by the insertion of the securing pin SP into the selected aperture AP and the tubular element TE and lock the pin in position in the aperture AL on the opposite side of the channel UC. As a result, the positioning of the foot F in the channel UC will be adjacent the stop member LL and the locking action at the opposite end of the shelf foot F can be completed by selecting an aperture AR that will cause the stop member LL to be mounted to the foot F in a non-movable position.

After the shelf units are all mobilized by a skate SK and the shelf units are locked to the skate SK, the gondola is in condition to be moved including with all of the goods on their designated shelves. This is done by coupling the pulling tools PT to each skate SK, such as hooking the ends of the tools PT to the loops U. Once this is accomplished, the entire gondola is in condition to be moved to another pre-selected location. This is accomplished by the moving personnel grasping (one or more movers) the coupled pulling tool and pulling on all of the skates SK substantially simultaneously to cause the gondola to move in unison in a desired direction and distance by rolling on the caster wheels CW and continuing the pulling forces until the gondola is re-positioned at the new location.

The advantages and features of the above described method and apparatus for moving a gondola can be better appreciated when contemplating an experimental use of the unique two wheeled lifting hand truck T and the skate SK for moving a gondola of a length of approximately 68 feet long and filly loaded with liquor bottles, a distance of four feet in approximately 45 minutes, including setting up and breaking down the apparatus, and without causing any liquor bottle to fall off a shelf of the gondola. This represents a substantial savings of time and labor for operators of chain stores or the like and down time for the stores.

In the above described method and apparatus for moving a gondola, the moving procedure could be carried out because the skate SK could be moved from one side of the shelf unit to the other side without encountering some obstruction such as electrical outlets or improper finishing of the shelf supporting surface to prevent a skate from being so positioned. In the event, this is the condition of the floor or the supporting surface and with particular reference to FIG. 14, a modified skate SK must be provided to allow the opposite ends of a shelf unit to be mobilized by a pair of mobilized shelf units, as illustrated in FIG. 14. The skates SKM of FIG. 14 are constructed similar to the skates SK except the posts P of a two sided shelf unit is not supported by the skates SKM. The skates SKM utilize a U-shaped channel UC to mount a foot F therein and are provided with a caster wheel support assemblies on each side of the channel UC.

1) A method for moving shelf units arranged in the form of a gondola of a preselected length having a plurality of shelf units including opposing vertical feet for supporting the shelf unit on a supporting surface including when the shelf unit is loaded with goods, said method including the steps of
providing a plurality of two wheel, hand lifting trucks having a lifting element secured to the front of the truck substantially centrally of the two wheels and extending outwardly thereof for permitting movement of the truck to place said lifting element under a vertical foot of a shelf unit,
moving a first of said hand trucks adjacent one end of a vertical foot of a shelf unit and lifting the foot off of the supporting surface a pre-selected distance while simultaneously moving a second of said hand trucks adjacent the opposite end of said vertical foot of a shelf unit and lifting said end of the vertical foot off of the supporting surface a pre-selected distance,
providing a plurality of skate means having caster wheel assemblies mounted thereto for permitting movement of the skate means, said skate means including a shelf foot receiving and supporting platform for mounting an individual shelf unit foot the entire length of the foot on said supporting platform for said skate means,
while the vertical foot is maintained lifted at said pre-selected distance above the supporting surface, by said lifting trucks, sliding said skate means between the wheels of the lifting trucks and under the elevated foot for the entire extent of the shelf unit foot and then removing the lifting trucks from the shelf unit thereby allowing the skate means to temporarily support said vertical foot on said supporting platform and then repeating the aforementioned steps of lifting an individual, shelf unit foot and sliding individual skate means under each vertical foot of the shelf unit until all of the vertical feet are mounted on said supporting platforms for the individual skate means for allowing the entire gondola of shelf units to be moved as a complete gondola while mounted on said skate means.

2) A method for moving shelf units arranged in the form of a gondola as defined in claim 1 including a plurality pulling tool means connectable and disconnectable from said skate means, and the step of connecting individual tool means to each individual skate means and moving the complete gondola by simultaneously pulling on all of said pulling tools.

3) A method for moving shelf units as defined in claim 1 including providing a plurality of individual stop means adjustably mounted to said skate means at opposite ends of said supporting platform for securing the opposite ends of a vertical foot when mounted on said skate supporting platform to prevent relative movement between the vertical foot and the skate supporting platform simultaneously for moving the gondola to another pre-selected location.

4) A method for moving as defined in claim 3 including the step of providing a plurality of individual stop means for use with said supporting platform in accordance with the length of the shelf unit mounted on said supporting platform, and selecting one of the individual stop means for securing the opposite ends of the vertical foot mounted on said skate in accordance with the length of the mounted shelf unit.

5) A method for moving a gondola of shelf units comprising a plurality of free standing shelf units arranged side by side and not connected to one another to permit the gondola to be moved as a unit including when fully loaded with goods, including the steps of
providing plurality of two wheel, lifting hand trucks characterized as having a lifting arm extending outwardly thereof intermediate the wheels and adapted to permit the lifting arm to be slidable under a shelf unit to be lifted,
moving a first lifting hand truck to an end shelf unit and positioning the lifting arm, adjacent the shelf unit to be lifted, and then slidably engaging the end of the shelf unit under the shelf unit with the lifting arm,
while the lifting arm is engaging the shelf unit, rotating the hand truck to cause the lifting arm to raise the end of the shelf unit a pre-selected distance above the supporting surface,
while moving said first lifting hand truck to said end shelf unit, moving a second lifting hand truck to the opposite end of the same shelf unit as said first hand truck and simultaneously engaging said opposite end of the shelf unit under the shelf unit with the lifting arm for said second lifting hand truck and rotating the hand truck to cause the lifting arm of the second hand truck to simultaneously lift said opposite end of said shelf unit,
while maintaining the ends of the shelf unit in its lifted position sliding a caster wheel supporting structure between the wheels of one of said hand trucks and in alignment with the lifting arm under the lifted shelf unit in a position to permit the entire elevated shelf unit to be mounted to said wheel supporting structure and then withdrawing said lifting hand trucks from the ends of said shelf unit and permitting the shelf unit to be movably supported on said wheel supporting structure,
and repeating the steps of lifting the ends of the remaining shelf units comprising the gondola, sliding an individual swivel caster wheel supporting structure under each of the remaining shelf units until they all rest on said supporting structures and are thereby adapted for movement to another location.

6) A method for moving shelf units including loaded shelf units having mounting feet including the steps of
providing a mobile, heavy duty lifting device adapted for slidably engaging the bottom of a mounting foot for lifting the foot a pre-selected distance above the supporting surface for the shelf units,
applying an individual lifting device to the opposite ends of a mounting foot for simultaneously lifting the entire mounting foot a pre-selected distance above the supporting surface for the shelf units,
providing skate means carrying swivel caster means and adapted for supporting the width of a shelf unit when the mounting feet are positioned onto said skate means,
sliding said skate means between the lifted mounting foot and the supporting surface the entire width of the shelf unit and then, simultaneously operating the lifting devices to cause the lifting foot to be mounted onto said skate means to be supported therefrom, while pulling the lifting devices away from the shelf unit,
repeating the above steps along the entire length of shelf units for further mobilizing the shelf units at each mounting foot and supporting the mounting foot on another of said skate means until each mounting foot is so mobilized to permit the shelf units to be moved in unison through said skate means.

7) A method for moving shelf units as defined in claim 6 including
applying a moving force to each of the skate means substantially simultaneously to cause the movement of the skate means to roll the shelf units to a different location.

8) A method for moving shelf units as defined in claim 7 including the step of applying a lifting device to the opposite ends of a mounting foot once the shelf units have been moved to said different location for lifting the mounting foot off of the individual skate means,
and while the mounting foot is so elevated, remove the skate means from under said shelf unit and allow the mounting foot to be supported on the mounting surface, and
repeating the latter mentioned steps for each mounting foot so that the shelf units are all supported on the mounting surface at the different location.

9) A method for moving free standing shelf unit and having vertical feet for supporting the shelf units on a supporting surface, said method including the steps of
providing a pair of lifting devices in the form of a two wheel, heavy duty lifting hand truck having a lifting arm adapted to be slidably moved under a supporting foot or the like for the shelf units, said lifting arm being arranged substantially centrally of said lifting hand truck,
simultaneously moving one of the lifting hand trucks under the opposite ends of a shelf mounting foot and lifting the mounting foot a pre-selected distance above the supporting surface,
providing a skate having wheel means and a platform for supporting at least a single supporting foot the entire width of a shelf unit,
while the mounting foot is spaced above the supporting surface, roll a skate between the wheels of said lifting hand truck in alignment with said lifting arm from one end of the mounting foot to the opposite end thereof for receiving the mounting foot on the supporting platform for said skate,
lowering the lifting truck for mounting the shelf mounting foot onto the supporting platform for the skate to be supported thereon and moved therewith,
moving the lifting trucks away from the shelf units and permitting the skate mounted mounting foot to be supported thereon and movably therewith,
repeat each of the above steps for mounting the other mounting foot of the same shelf unit to a skate to cause the shelf unit to be mobilized by the shelf supporting skate.

10) A method as defined in claim 9 including securing the mounting foot to the supporting skate for preventing relative movement between the skate and the shelf unit during the movement off a shelf unit.

11) A method as defined in claim 9 or 10 wherein the wheel means for the skate comprises swiveling caster means, and including moving the skate mobilized shelf to a pre-selected different location.

12) A heavy duty, two wheel lifting hand truck comprising
a heavy duty cross bar,
an individual, wheel mounting element secured adjacent each end of said cross bar to depend, therefrom,
wheel means coaxially rotatably mounted to an individual one of said mounting elements, the wheel means being mounted for maintaining said wheel mounting elements spaced from said supporting surface when the wheels are supported therefrom,
a lifting arm secured at one end to said cross bar intermediate the ends thereof and extending outwardly therefrom at a pre-selected angle and having a lifting end adapted to be slidably moved under a shelf supporting structure for temporarily lifting a shelf supporting structure upon a lifting force being applied thereto, and
lever means secured to said cross bar intermediate the ends of the cross bar and adapted for permitting the manual movement of the lifting hand truck, said lever means extending outwardly and upwardly from said cross bar at a pre-selected angle with the supporting surface and a pre-selected operative length to provide a lifting force to a shelf supporting structure upon the rotation of the lever means in a counter clockwise direction and the lifting end of said lifting arm is engaged under a shelf supporting structure.

13) A heavy duty, two wheeled lifting hand truck as defined in claim 12 including an extension arm adapted to be secured to an end of the lever means to enlarge the operative pre-selected length thereof, said extension arm having a cross-member secured thereto to allow a plurality of individuals to apply a lifting force thereto.

14) A heavy duty, two wheeled lifting hand truck as defined in claim 12 including support means secured to the lever means and extending outwardly therefrom for mounting said lever means at a pre-selected angle with the supporting surface and thereby defining at rest position.

15) A heavy duty, two-wheeled hand truck as defined in claim 12 wherein the lifting end of said lifting arm being constructed and designed to flatly overlie a supporting surface when said lever means is moved in a clockwise rotation to assume a vertical orientation with a supporting surface to permit said lifting end to be slidably moved under the shelf supporting structure and lift the supporting structure when said lever means is moved in a counter clockwise direction.

16) A heavy duty, two wheeled hand truck as defined in claim 15 wherein the lifting end of said lifting arm is constructed and designed with a pre-selected shape for facilitating the lifting end's slidable movement under a supporting structure to be lifted.

17) A heavy duty, two wheeled hand truck as defined in claim 16 wherein the lifting end of said lifting arm is tapered to provide an end for entry under a supporting structure to be lifted.

18) A heavy duty, two wheel lifting hand truck comprising
a heavy duty cross bar,
a pair of wheels coaxially rotatably mounted adjacent opposite ends of said cross bar,
lever means secured to said cross bar for permitting the manual movement of the lifting truck,
a lifting arm secured at one end to said cross bar intermediate the ends thereof and extending outwardly therefrom, said lifting arm having a lifting end adapted to be slidably moved under a supporting structure for shelf assembly for temporarily lifting said supporting structure, said lifting end being constructed and designed to flatly overlie a supporting surface when said lever means is moved in a clockwise rotation to assume a vertical orientation with a supporting surface to permit said lifting end to slidably engage under said supporting structure and lift the supporting structure when said lever means is moved in a counter clockwise direction.

19) A heavy duty, two wheeled lifting hand truck comprising
a heavy duty cross bar,
a pair of wheels means individually coaxially rotatably mounted adjacent opposite ends of said cross bar,
a U-like lever means secured to said cross bar for the manually movement of said lifting truck, and
a lifting arm secured at one end to said cross bar intermediate the ends of the lifting arm and extending outwardly thereof, said lifting arm having a lifting and adapted to be slidably moved under a supporting structure for a shelf assembly for temporarily lifting said supporting structure, the said lifting end being constructed and designed to flatly overlie the supporting surface when said lever means is moved to assume a vertical plane to permit sliding engagement with said supporting structure and lifting said structure when said lever means is moved downwardly

20) A heavy duty, two wheel lifting hand truck as defined in claim 19 including support means secured to said lever means for supporting the lever means on its supporting surface at a pre-selected angle spaced between said horizontal and vertical planes.

21) A heavy duty, two wheel lifting hand truck as defined in claim 19 including handle means having a pre-selected length secured to the lever means at the opposite end from said cross bar for controlling the movements of the hand truck and for exerting a lifting force thereto for lifting said supporting structure upon engagement between said lifting end of the lifting arm and said supporting structure due to lever action.

22) A heavy duty, two-wheeled lifting hand truck as defined in claim 21 wherein said handle means is adapted to mount an extension arm to free end of said handle means.

23) A heavy duty, two wheeled lifting hand truck as defined in claim 22 wherein said extension arm has a cross member secured to the free end of said extension arm at approximately a right angle to the axis of the extension arm to permit two individuals to exert lifting force thereto.

24) A mobile, heavy duty lifting hand truck for supporting a heavy article during the lifting of the heavy article in the form of loaded shelving units in the form of a “gondola” or the like, said mobile, lifting hand truck comprising a pair of spaced side rails arranged in a U-like configuration, a heavy duty bar means secured at the open end of said U-like configuration and thereby closing said configuration into a unitary configuration,
wheel means individually rotatably secured adjacent the opposite ends of said bar means for rendering the hand truck manually mobile, and
flat bar means mounted to said bar means, intermediate its ends and extending outwardly of said bar means at a pre-selected distance and angle and having a lifting plate means arranged at a pre-selected angle to said flat bar means so that when the side rails are moved to extend in a substantially vertical plane to the wheel supporting surface the lifting plate means flatly, overlies said supporting surface and is adaptable to be slidably moved under the supporting foot or the like, for the shelving units and being responsive to a rotary force applied through said side rails to lift the supporting feet upwardly a preselected distance above said supporting surface when positioned under said supporting feet.

25) A mobile lifting truck comprising a heavy duty supporting structure having a preselected length including means for rotatably mounting wheel means adjacent the ends of said supporting structure, wheel means coaxially and individually mounted at each of said means for mounting wheel means,
a lifting arm secured at one end to said supporting structure and being constructed and designed to extend outwardly of said supporting structure at a pre-selected angle, said lifting arm having a lifting plate adapted to be slidable under an object to be lifted when moved adjacent the object to be lifted,
handle means in the form of a lever means having one end secured to said supporting structure for transmitting a lifting force to said lifting arm for at elevating an object to be lifted off its supporting surface when said lifting plate means is under an object to be lifted and a downwardly acting force is applied to the handle means,
said lifting plate for the lifting arm being arranged to assume a flat, parallel relationship with the supporting surface when an upwardly acting force is applied to the handle means to move the handle means to a substantially vertical position relative to the supporting surface for sliding movement under an object to be lifted and then the application of the downwardly acting force to the handle means for lifting the object resting on the lifting arm plate.

26) A mobile lifting truck as defined in claim 25 wherein said lifting plate is a relatively thin plate having a chisel-like end for slidable movement under an object to be lifted.

27) A gondola skate for sliding movement including under a gondola of shelving units and the shelf supporting structure having supporting feet, for temporarily supporting and mobilizing the gondola of shelving units comprising
a U-shaped channel constructed and designed to receive and partially support at least a pair of supporting feet, side by side, within said channel for a pair of shelving units arranged side by side upon mounting onto the channel,
a plurality of wheel support assemblies, each assembly having an inverted L configuration with one leg of the L secured to the outside of the channel adjacent opposite sides of said channel and adjacent each end of said channel, the secured support assemblies extending beyond the open end of the U-shaped channel,
a corresponding plurality of caster wheel assemblies for said caster wheel support assemblies, one caster wheel assembly being secured to an individual support assembly,
a plurality of stop means adjustably secured adjacent the opposite ends of the U-shaped channel for permitting shelf supporting feet to be locked in place in said channel to prevent relative movement between said shelf and said skate.

28) A gondola skate as defined in claim 27 wherein said support assemblies includes means for receiving and coupling thereto a pulling tool to permit the gondola skate to receive a moving force upon the application of such a force to said pulling tool transmitted to said support assemblies and thereby said skate.

29) A gondola skate as defined in claim 28 wherein said means for receiving and coupling a pulling tool comprises a coupling loop secured to at least one of said caster wheel support assemblies, said tool comprising a rod adapted at one end to be coupled to said coupling loop for transmitting a moving force to the coupled gondola skate to cause it to roll on said caster wheels and thereby carry the gondola of shelving units.

30) A gondola skate as defined in claim 29 wherein said coupling loop comprises a U-shaped loop.

31) A heavy duty skate for mounting under a shelving unit for a loaded gondola or the like upon the shelving unit having one end of the shelving unit lifted off of its supporting surface, said skate comprising
a U-like , heavy duty channel arranged with the open end of the base of the channel lying substantially flat with the supporting surface and the open end constructed and designed for receiving supporting legs of shelving units when the supporting legs are dropped into said channel a first pair of swiveling casters,
first heavy duty support means secured adjacent an end of said channel, one of said first means secured on each side of said channel and individually securing a swiveling caster thereto of said first pair of casters,
a second pair of swiveling casters, and
second heavy duty support means secured to the opposite end of said channel from said first heavy duty support means, one on each side of said channel and individually securing a swiveling caster thereto of said pair of casters whereby the skate supports a supporting foot for a shelving unit the entire width of the shelving unit when positioned into said channel to be supported thereon to be movable with the movements of said skate.

32) A heavy duty skate as defined in claim 31 including first means adjustably mounted to said channel adjacent one end thereof for engaging an end of a supporting foot when mounted in said channel for limiting any relative movement between said foot and the skate, and
a second means adjustably mounted to said channel adjacent the opposite end of said channel from said first means for engaging and securing the opposite end of the supporting foot for limiting any relative movement between said foot and the skate.

33) A skate for rendering two sided shelf units arranged in a gondola for movably supporting the two sided shelf units the entire width of the shelf units, said two sided shelf units having supporting feet at opposite ends of the shelf and a supporting partition between the two shelf units and a partition mounting foot for the partition, said skate comprising heavy duty skate as defined in claim 32 including
a third pair of swiveling caster wheels,
a third heavy duty support means secured intermediate the ends of said channel for receiving and supporting said partition mounting foot in said channel, one of said third means secured on each side of said channel and individually securing a swivel caster wheel thereto of said pair of swiveling casters to thereby support the entire width of the two sided shelf units.

34) A gondola skate for rolling movement including under a plurality of double sided shelving units arranged in a side by side arrangement, each shelving unit having supporting feet, the gondola being constructed and designed with sufficient structural strength for temporarily supporting the double sided shelving units and rendering the plurality of shelving units, movable on the gondola skates including when shelving units are loaded with goods, said gondola skate comprising
a shallow U-shaped channel arranged, constructed and designed to receive and partially support at least a pair of supporting feet for the shelving units arranged in a side by side arrangement upon the lifting of said supporting feet onto said channel,
a plurality of caster wheel support assemblies secured to said channel adjacent the ends of the channel and intermediate the ends thereof, the support assemblies extending above the top of said channel for receiving and supporting the shelving units thereon and all said assemblies terminating in the same horizontal plane,
a corresponding plurality of caster wheels for said support assemblies, one caster wheel assembly being secured to an individual support assembly, and means for securing a supporting foot(s) to said U-shaped channel for preventing relative movement between said supporting foot and said gondola skate.

35) A gondola skate as defined in claim 34 wherein said plurality of caster wheel support assemblies comprises an individual support assembly secured to opposite sides of said U-shaped channel, and an individual swiveling caster wheel secured to each of said support assemblies.

36) A gondola skate as defined in claim 34 or 35, wherein said means for securing a supporting foot comprises stop means adjacent each end of said U-shaped channel for adjustably securing a supporting foot in a non-movable relationship with said channel.

37) A gondola as defined in claim 34 or 35 including a pulling tool adapted to be releasably coupled to the gondola skate for pulling the gondola of shelf assemblies when coupled to the gondola skate to cause the supported shelf assemblies to be rolled to another location.

38) A gondola skate for slidable insertion between a gondola of a plurality of shelving units having supporting feet and a gondola supporting surface for the temporary support to permit moving the gondola when a plurality of said skates are inserted under each supporting foot for the gondola of shelves, comprising a U-shaped channel constructed and designed to receive at least a pair of supporting feet for shelving units arranged side by side when the U-shaped channel is supported on a supporting surface with the open end of channel adapted to receive and support a supporting foot or a pair of supporting feet when positioned thereon through the open end,
a plurality of caster wheel support assemblies, having an overall inverted L-shape for mounting on opposite sides of said U-shaped channel, adjacent each end thereof, a plurality of individual swiveling caster wheel assemblies individually secured within an individual support assembly, one in each support assembly for mobilizing said channel, a first stop means adjustably secured adjacent one end of said channel in accordance with the length of a supporting foot to be mounted therein and a second adjustable stop member mounted adjacent the other end of said channel for engaging the adjacent end of a supporting foot and adjustable to lock said foot to said channel.
